(19) United States
(12) Patent Application Publication
(10) Pub. No.: US 2026/0026533 A1
(43) Pub. Date: Jan. 29, 2026

(54) FOOD ITEM

(71) Applicant: HENRI NUTRITION INC., Québec (CA)

(72) Inventor: Vanessa GRONDIN, Québec (CA)

(21) Appl. No.: 19/273,252

(22) Filed: Jul. 18, 2025

Related U.S. Application Data
(60) Provisional application No. 63/676,387, filed on Jul. 28, 2024.

(51) Int. Cl. A23L 19/00; A23L 11/00; A23L 25/00; A23P 10/00

(52) U.S. Cl. CPC A23L 19/09; A23L 11/05; A23L 25/30; A23P 10/00

(57) ABSTRACT

The food item can have a solid structure occupying a volume and weighing at least 20 grams and having a density between 1.25 g/cm³ and 1.65 g/cm³, the solid structure having a mix of: between 30 and 50% by weight of a mashed dried fruit; between 35 and 50% by weight of a seed meal; and between 1 and 20% by weight of a legume meal, the latter three ingredients forming a nutritious self-supporting matrix of whole ingredients to which flavoring and/or other ingredients may be added for consumer enjoyment.

### TECHNICAL FIELD

This application relates to food items, particularly whole ingredient bars as an alternative to ultraprocessed snacks.

### BACKGROUND

Adult, child and adolescent obesity and diabetes in developed countries are growing at an alarming rate. According to the World Health Organization (WHO), in 2022, 1 in 8 people in the world is living with obesity. Worldwide adult obesity has more than doubled since 1990, and adolescent obesity has quadrupled. In 2022, 37 million children under the age of 5 were overweight. Over 390 million children and adolescents aged 5-19 years were overweight in 2022, including 160 million who were living with obesity.

Ultraprocessed foods have been used as snacks for adults and children for decades. Over recent years, there has been an increased awareness regarding the nutritional value of such snacks. Many parents have become aware that the snacks they offer their kids are not considered “highly nutritious”. In many cases, processed foods have a high sugar content, a low protein content, and/or a low fiber content, relative to their calorific value when compared to natural foods that are not ultraprocessed. Sugar has been used somewhat used as a glue to adhere nut based and carbohydrate-heavy ingredients in order to achieve self-supporting structures such as “bars”. Baking is also used to make self-supporting structures such as “cookies”.

While many parents have been wanting to provide more nutritious and less processed snacks to their kids, for many years, available food items have surprisingly not evolved much to meet this need. In fact, there are many challenges to achieving a commercially viable product that meets this need. Two significant challenges are i) to provide a product which people will enjoy eating and ii) to provide a product which can be offered at a price affordable and reasonable for consumers in order to make industrial production viable. There are still additional challenges, such as providing products which have a sufficient shelf stability, meaning that the quality of the product will not degrade too quickly or require particular procedures (e.g., refrigerating). Of course, providing a food item in the form of a self-supporting structure, as opposed to in the form of a powder for instance, can be essential for the product to be considered “palatable”. There thus remains room for improvement.

### SUMMARY

It was found that such challenges could be addressed via a particular composition of matter in a food item. The food item is a solid structure occupying a volume and this composition of matter includes from 30 to 50% by weight of at least one mashed dried fruit; from 30 to 50%, from 35 to 50% or from 35 to 45% by weight of at least one seed meal; from 1 to 20%, from 1 to 15%, from 2 to 20% or from 5 to 20% by weight of at least one legume meal, and from 0 to 34% by weight of at least one other ingredient. The term “other ingredient” as used herein refers to an edible ingredient, preferably a natural ingredient, such as may improve granulometry, texture, taste and/or nutritional value. In many embodiments, the food item of the present disclosure is free of traditional binding agents used to keep the ingredients together in the form of a food bar, and the matrix elements of whole natural ingredients, namely the mashed dried fruit, seed meal and the legume meal, can inherently provide satisfactory binding to achieve a structure having a density between 1.25 g/cm³ and 1.165 g/cm³, such as around 1.45 g/cm³.

Traditional binding agents are well known to the skilled person and include glucose syrup, high-fructose corn syrup (HFCS), maltodextrin, inverted sugar, brown rice sugar, agave syrup, dextrose, crystalline fructose, evaporated cane juice, sugar alcohols (sorbitol, maltitol, xylitol), tapioca syrup, brown sugar syrup, corn syrup, inulin and combinations thereof. In some embodiments, the at least one other ingredient is defined herein so as to exclude the aforementioned binding agents. Such binding agents do not constitute natural ingredients. Such binding agents do not constitute flavoring agents. Such binding agents do not constitute fibrous ingredients. In at least some embodiments, the at least one other ingredient includes at least one nutritional addition that provides nutritional value to the food item (i.e. increase protein or fiber content or concentration). The at least one other ingredient may also include a flavoring agent. In sone embodiments, the total percentage of the flavoring agent is provided in a concentration of from 2 to 15% by weight. In some embodiments, the other ingredient includes one or more fibrous ingredients as providing nutritional value through an increase fiber content at a concentration of from 2 to 10% by weight. It should be understood that the at least one mashed dried fruit, the at least one seed meal, the at least one legume meal and the at least one other ingredient total 100% by weight. Accordingly, in some embodiments, the food item consists of the at least one mashed dried fruit, the at least one seed meal, the at least one legume meal and the at least one other ingredient. In further embodiments, the food item consists of the at least one mashed dried fruit, the at least one seed meal, the at least one legume meal, and the at least one flavoring agent.

Indeed, it was found that mashed dried fruit material (such as whole mashed dried fruit) like dates in particular, can provide an amalgamating role in achieving the desired structure, while also providing some sweetness and fibers. This advantage in achieving the desired structure allows to preferably exclude the traditional binding agents. The term “whole” as used herein in any context can refer to comprising at least 99% by weight or being consisting essentially of. Raisins can be a substitute to dates, and, to a certain extent, figs and/or apricots may be used as well, individually or by mixing some or all of such dried fruits. The term at least one mashed dried fruit, in some embodiments, is thus defined as including one or more of mashed dried dates, mashed dried figs, mashed dried raisins or mashed dried apricots. The term “mashed” can be defined as containing pieces or chunks of the fruit having a size of from 0.1 cm to 2 cm, 0.2 cm to 1 cm, or 0.4 to 0.7 cm. The term “size” as used herein can refer to the diameter but in cases where the shape is irregular or non-spheroidal can refer to the greatest distance between two opposite points of the fruit piece or chunk. In some embodiments, the mashed dried fruit has from 50 to 100% by weight of dates, preferably from 90 to 100%. When the dates are not 100% by weight of the mashed dried fruits, the remainder may be selected from apricots, raisins, figs and combinations thereof.

Seed meal, such as whole crushed seeds, can be used to provide a nutritional contribution in protein, fibers, and fat, and legume meal, such as a flour of vegetable protein ingredient(s) like a powder of broad beans (e.g., Vicia faba beans) and/or a powder of beans or pulses such as soy beans, peas and/or white beans, can be used to increase protein content and/or as a binder and/or for absorbing vegetable oil released by the crushing of the seeds, for example. The at least one seed meal may be provided in a crushed form, having a particle size of less than 2 cm, less than 1.5 cm, less than 1 cm, less than 0.5 cm, or less than 0.1 cm. The at least one legume meal may be provided in a crushed form, having a particle size of less than 300 μm, less than 250 μm, less than 200 μm, or less than 150 μm. In some embodiments, at least 5% of the at least one seed meal has a granulometry below 50 microns. In some embodiments, at least 80% by weight of the at least one mashed dried fruit has a granulometry below 2000 μm. In some embodiments, at least 80% of the at least one seed meal has a granulometry below than 2000 μm. It will be noted that the edible structure can be achieved without using any ingredient which constitutes a mandatory disclosure allergen (i.e., an ingredient which must be disclosed as an allergen when incorporated to a food item in many, most or all countries). It will be noted that the at least one legume meal (e.g., a powder of pulses) may need to be treated in a bath of vapor to inhibit enzymes which may otherwise cause an off flavor. While the seed meal and the legume meal may not be suitable for being made in the form of a self-supporting structure in and of themselves, mixing them with the mashed dried fruit can lead to a suitable, chewy structure. In at least some embodiments, the at least one seed meal has from 50 to 100% by weight of squash seeds or the at least one seed meal has from 50 to 100% by weight of pumpkin seeds. In at least some embodiments, the at least one legume meal has from 50 to 100% by weight of broad beans. Preferably, the legume meal has 90% of its particles at a size of 150 microns or less, at a moisture of 10% of less. In at least some embodiments, the at least one seed meal consists of squash seeds, pumpkin seeds and the combination thereof. In at least one embodiments, the at least one legume meal consists of broad beans.

The production process can involve blending the dried fruits (which can preferably be whole except for any inedible seeds or hard cores which could have previously been removed) together with the seeds (which can preferably be whole). This can allow to simultaneously mash the dried fruits and crush the seeds which may both be faster and easier to process than mashing the dried fruits alone and can thus lead to efficiency and performance gains. In some embodiments, the process can begin by crushing whole seeds in a blender, once a targeted granulometry has been reached (such as the sizes described above), the dried fruits are added to the crushed seeds, and once a desired texture is reached, the legume meal is added, which may have previously been processed from the beans or pulses to form a powder. In such embodiments, any additional flavoring and/or additional ingredients (i.e. the at least one other ingredient) can be added before, after, or together with the legume meal. In some embodiments, the blended ingredients can then be extruded or rolled into a slab, and cut into individual food items.

In accordance with one aspect, there is provided a food item comprising: a solid structure occupying a volume and weighing at least 20 grams, the solid structure having a mix that comprises or consists of: from 30 to 50% by weight of at least one mashed dried fruit; from 35 to 50% by weight of at least one seed meal; from 1 to 20% by weight of at least one legume meal and from 0 to 34% by weight of at least one other ingredient.

In accordance with another aspect, there is provided a food item comprising a solid structure occupying a volume and weighing at least 20 grams, the solid structure having a mix that comprises or consists of: from 30 to 50% by weight of mashed dates, from 35 to 45% by weight of pumpkin seed meal, from 5 to 20% by weight of at least one legume meal and from 0 to 34% by weight of at least one other ingredient.

In accordance with another aspect, there is provided a food item comprising a solid structure occupying a rectangular parallelepiped volume and weighing between 20 and 70 grams, the solid structure having a heterogeneous mix that comprises or consists of: from 35 to 50% by weight of at least one mashed dried fruit consisting mostly of mashed dates, from 35 to 50% by weight of at least one seed meal consisting essentially of crushed pumpkin seed, from 3 to 20% by weight of at least one legume meal, and from 0.5 to 15% by weight of at least one flavoring agent. In at least some embodiments, the solid structure weighs between 20 and 55 grams, contains more than 4 grams of protein, more than 2 grams of fiber, has less than 250 calories, has a caloric density index between 4 and 10 calories per gram, has a glycemic index below 55, preferably between 35 and 45. The food item can contain more than 3 grams of fiber and a combined amount of protein and fiber between 7 and 16 grams.

In some embodiments, the food item can be characterized by a density of from 1.4 to 1.5 g/cm³, from 1.42 to 1.48 g/cm³, or from 1.43 to 1.47 g/cm³.

In accordance with another aspect there is provided a process of making food items, the process comprising: blending between 30 and 50% by weight of dried fruit with between 35 and 50% by weight of seeds and between 1 and 20% by weight of legume meal to form a food item mix; compacting the food item mix into a slab; and cutting the slab into a plurality of food items each having at least 20 grams.

The blending can include crushing the seeds and mixing the dried fruit into the crushed seeds. The blending can include mixing the legume meal into the mixed dried fruit and crushed seeds.

In accordance with any of the present embodiments, the food item is free of or is fabricated in a method that is free of binders such as glucose syrup, high-fructose corn syrup (HFCS), maltodextrin, inverted sugar, brown rice sugar, agave syrup, dextrose, crystalline fructose, evaporated cane juice, sugar alcohols (sorbitol, maltitol, xylitol), tapioca syrup, brown sugar syrup, corn syrup, inulin and combinations thereof.

### DESCRIPTION OF THE FIGURES

FIG. 1 is a photograph of a food item according to an exemplary embodiment.

### DETAILED DESCRIPTION

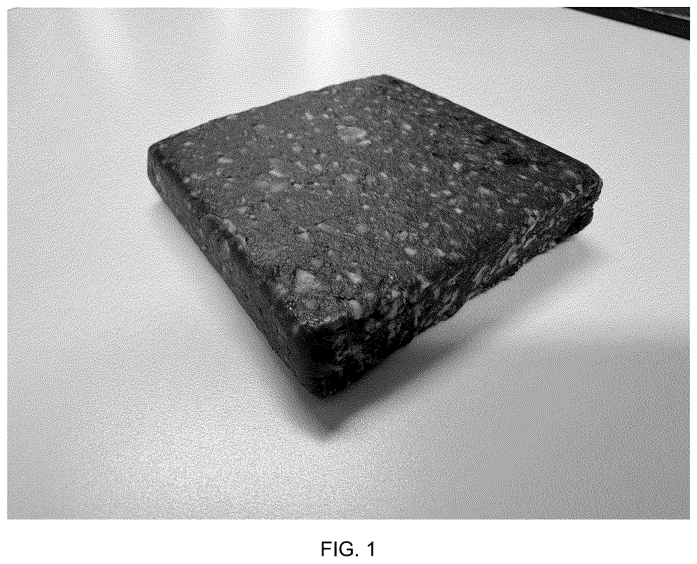

FIG. 1 is a photograph of an example food item having a solid structure occupying a rectangular parallelepiped volume and weighing between 20 and 70 grams (g), such as between 20 an 55 grams, the solid structure having a heterogeneous mix of: from 30 to 50% by weight of at least one mashed dried fruit; from 35 to 50%, such as from 35 to 45%, by weight of at least one seed meal; from 1 to 20%, such as from 5 to 20%, from 3 to 15% and from 5 to 10% by weight of at least one legume meal; and from 0 to 34% by weight of at least one other ingredient. The solid structure can be achieved by blending and compacting the ingredients. The food item can provide a nutritious, shelf-stable snack, made of whole, minimally processed ingredients. The food item can be free from allergens such as milk, eggs, peanuts, fish, soy, wheat and sesame. The food item can meet a kid's, an adolescent's or an adult's nutritious needs for a snack or breakfast. The expression “meal” refers to a granular or powdery texture that can result from at least some degree of crushing or grounding.

From a chartered nutritionist's standpoint, as calculated in a nutritional facts table that complies with the Food and Drug administration (FDA) and the Canadian food inspection agency (CFIA), the following table may present features associated with the expression “nutritious” for a snack, i.e., a food item having between 20 and 70 grams or between 20 and 55 grams.

TABLE 1
criteria associated to the expression “nutritious”

| | |
|---|---|
| protein content | 4 g to 12 g, around 7 g or more being preferred |
| fiber content | 2 g to 14 g, or around 3 g to 6 g being preferred |
| sugar content | 5 g to 15 g, or around at least 9 g being preferred |

In an exemplary embodiment, pitted whole dried dates were used as a dried fruit ingredient which has the characteristic of being naturally high in fiber and in natural sugars as well as not being a mandatory disclosure allergen. Whole dates were mashed, blended and extruded into the form of a commercially typical snack bar, i.e. having a rectangular parallelepiped shape and a weight of between 20 and 70 grams or between 20 and 55 grams. Various iterations were made with dates that were either cut in pieces, nibs or paste texture. Various experiments were made to combine one or more textures to form a food item. Although the food item could hold together, it had a chewy and sticky texture which was unappealing from a commercial standpoint. The product had a water activity below 0.69, making it shelf-stable. The food item had a stable shape but it did not meet the above-identified criteria with regards to protein, fiber or sugar content. Sugar density was around 63%, which is undesirably high for a snack. Alternative experiments were made with other dried fruits such as apricots, raisins, figs. The results were similar with regards to being able to produce a sticky structure that had a very high sugar content. Although the sugar is naturally present in the fruits, which can constitute a source of sugar which is preferred over processed sugars, the resulting high concentration of sugar remains undesirable.

In another example embodiment, pumpkin seeds were used as a whole ingredient. Pumpkin seeds are naturally high in protein, fiber, fat, as well as not being a priority allergen. Pumpkin seeds were crushed to obtain various granulometry, from very coarse, coarse, to fine, to butter. Various iterations were made to create a food item that has a structure that holds together and can be compared to other commercially available snacks. Various experiments were made to combine one or more textures to form a food item. However, the food item could not hold together, regardless of the granulometry, it was brittle and unstable which was unappealing from a commercial standpoint. The product had a water activity below 0.69, making it shelf-stable. While not offering a stable structure, crushed pumpkin seeds remained interesting with regards to the criteria of protein density, fiber density, and sugar density.

In another example embodiment, broad beans were used as a whole ingredient. Broad beans are naturally high in protein and fibers as well as not being a mandatory disclosure allergen. Broad beans are known for being highly nutritious but also having off-flavours that can be unpalatable. These off-flavours can constitute a commercial limitation to wider use of this ancient bean. To maintain an optimal nutritional profile, the use of whole beans is preferable as opposed to protein concentrate or protein isolates. It was found that the enzymes that cause the undesirable off-flavours can be deactivated, to a suitable degree, by steaming the whole raw broad beans. Subsequently to steaming, the broad beans can be milled at various granulometry to test texture, structure and taste. The resulting broad bean material had a raw, coarse, and nib texture which was hard to chew and unsatisfactory from a taste and palatability perspective. Various iterations were made to create a food item that has a structure that holds together and can be compared to other commercially available snacks. Various experiments were made to combine one or more textures to form a food item. The milled broad beans could not hold together, the resulting structure was brittle and unstable which was unappealing from a commercial standpoint. The product had a water activity below 0.69, making it shelf-stable. The food item did not have a stable structure but it was interesting with regards to criteria such as protein density, fiber density and sugar density.

In another example embodiment, various experiments were made to combine dates, pumpkin seeds and broad beans, treated as explained above, to create a food item having a commercially acceptable structure, which further complies with the criteria listed in table 1. From the previous experiments, various textures were tested in various combinations. A suitable structure meeting the criteria listed in table 1 was obtained.

FIG. 1 presents an example of such a food item. The conditions under which the food item was achieved are presented below.

It was found that using pumpkin seeds crushed so that at least 5% of the weight has a granulometry of 50 microns or less could provide pumpkin seed meal suitable structure in the resulting food item. In some embodiments, the pumpkin seeds were crushed so that at least 80% of the pumpkin seeds had a granulometry of 2000 microns or less. At a granulometry of 50 micrometres, the pumpkin seeds develop a buttery texture. At that granulometry, the naturally occurring oils can be available to bind with the broad beans and dates as well offering a natural flavour vector. The melting point of the naturally occurring oil in the pumpkin seeds is 15.39° C. Hence, the naturally occurring oils of the pumpkin seeds are at a liquid state at room temperature. The pumpkin seed meal can act as a lubricant agent and add plasticity to the structure of the food item. Therefore, in preferred embodiment, the seed meal consists essentially of pumpkin seeds having a size of from 5 to 100 micrometers, 10 to 75 micrometres or 40 to 60 micrometres. In at least some embodiments, throughout the present disclosure the term “size” refers to the entirety of the particles, or at least 80%, at least 85%, at least 90% or at least 95% by weight. Indeed, the skilled person understands that there are sometimes outliers in the granulometry and a variability in the size distribution.

Experiments were made with various concentrations of pumpkin seed meal in the food item. In the experiments where the pumpkin seed meal was at a concentration of above 45%, particularly at a concentration of above 50% (by weight), the structure of the food item tended to become brittle and unstable. When the pumpkin seed meal was below 35%, it was found more difficult to meet the nutritious criteria of table 1. Other types of seed, such as squash seeds, sunflower seeds, and/or chia seeds, may be used partially or entirely as alternatives to pumpkin seeds. Accordingly, in some embodiments, the food item has between 35 and 45%, about 40%, or between 35 and 50%, by weight, of the seed meal.

Experiments were done with pumpkin seeds to quantify the optimal functional ratio, granulometry and % of that meal in the food item. Hardness was subjectively evaluated as either being: soft (S), ideal (I) or hard (H). Ideal is the hardness to be achieved. Brittleness was evaluated as either being sludgy (S), flexible (F) or brittle (B). Flexible is the brittleness to be achieved. The best results we obtained when pumpkin seeds were at a ratio of 35%-45% to have an ideal hardness, brittleness while meeting nutritional requirements.

TABLE 2
Experiments performed with various
configurations of pumpkin seed meal

| | Granulometry | | | Result- | |
|---|---|---|---|---|---|
| % (W/W) | of pumpkin | % of meal at | Result- | ing | |
| pumpkin | seed meal | the specified | ing | Brittle- | Nutriti- |
| seed meal | (microns) | granulometry | Hardness | ness | ousness |
| 20 | 50 | 100 | S | S | No |
| 20 | 2000 | 100 | H | F | No |
| 20 | 50 | 5 | I | F | No |
| | 2000 | 95 | | | |
| 40 | 50 | 100 | S | S | Yes |
| 40 | 2000 | 100 | I | F | Yes |
| 40 | 50 | 5 | I | F | Yes |
| | 2000 | 95 | | | |
| 60 | 50 | 100 | S | S | No |
| 60 | 2000 | 100 | H | B | No |
| 60 | 50 | 5 | H | B | No |
| | 2000 | 95 | | | |

Dates provide a structure and elasticity to the food item that can be subjectively characterized as chewy and sticky. Experiments were made with various concentrations of mashed dried dates in the food item. It was observed that the food item structure became brittle when 100% of the mashed dried dates had a granulometry above 4000 microns. The structure was somewhat brittle when the 100% of the mashed dried dates had a granulometry of between 2000 and 4000 microns. The structure was stable and commercially acceptable when the mashed dried dates had a granulometry below 2000 microns. However, it is observed that a certain percentage by weight of particles above 2000 microns, such as 20% of the mashed dried dates by weight for instance, can remain present in the food item without a significant effect on structure. Particle size variations can be interesting for palatability reasons. Dates were mixed at a proportion of 30%-50% to achieve a stable food structure. Moreover, to comply with the nutritious requirements, a proportion of 30%-40% is best suited.

Experiments were made with various concentrations of mashed dried dates in the food item. When the mashed dried dates were provided at a concentration of below 35%, particularly below 30% (by weight), the resulting food item lacked cohesion in some embodiments. When the mashed dried dates were above 40% (by weight) of the food item, it was found more difficult to meet the criteria of table 1, namely the sugar density. Other types of dried fruit than dates, such as raisins, figs and apricots, may be used partially or entirely as alternatives to dates.

Experiments were done with dates to quantify the optimal functional ratio, particle size, nutritiousness and percentage of that component in the food item. Hardness was evaluated as either being: soft (S), ideal (I) or hard (H). Ideal is the hardness to be achieved. Brittleness was evaluated as either being sludgy (S), flexible (F) or brittle (B). Flexible is the brittleness to be achieved. The best results were obtained when dates were at a ratio of 35%-40% to have an ideal hardness, brittleness while meeting nutritional requirements.

TABLE 3
Experiments performed with various configurations
of mashed dried dates

| % (W/W) | Size of | % of mash at | | | |
|---|---|---|---|---|---|
| dates in | particle | a given | | | nutriti- |
| formula | (microns) | particle size | Hardness | Brittleness | ousness |
| 20 | 4000 | 100 | H | B | No |
| 20 | 2000 | 100 | H | B | No |
| 20 | <2000 | 100 | H | B | No |
| 40 | 4000 | 100 | H | B | Yes |
| 40 | 2000 | 100 | H | F | Yes |
| 40 | <2000 | 100 | I | F | Yes |
| 60 | 4000 | 100 | H | B | No |
| 60 | 2000 | 100 | H | B | No |
| 60 | <2000 | 100 | I | F | No |

Accordingly, in some embodiments, the food item has between 30 and 50%, between 30 and 45%, between 35 and 45%, or about 40% by weight of mashed dried fruit. As used herein the term “dry” may be defined as having less than 10% moisture, preferably less than 5%, less than 3% or even less than 1%.

Broad bean meal can provide a binding/linking function between the mashed dates (which may provide a structure, adhesive, and elasticity function) and pumpkin seed meal (which may provide a lubricating and plasticizer function). Broad bean meal can also tend to absorb oil released from crushing seeds, and which may otherwise impart an undesirable viscous/sticky texture on the external surface of the food item. Various experiments were made with broad bean meal in various configurations, together with mashed dates and pumpkin seed meal in the food item. In some embodiments, for the broad bean meal to be suitable binder, 90% may need to be under 150 microns. When the broad bean meal was coarser, the structure of the food item tended to become brittle, less chewy (and less plastic). It was observed that in some embodiments, using between 1%-20%, between 5 and 20%, between 3 and 15% or between 5 and 20% by weight of broad bean meal in the food item led to a suitable commercial structure. In some embodiments, when the broad bean meal was present in concentrations above 15% by weight, the resulting structure was hard and less agreeably chewable, which can be compensated to a certain extent by increasing the ratio of dried fruit to seeds. In some embodiments, when the broad bean meal was present at 25% by weight, the resulting food item was found to have unsatisfactory brittleness. In some embodiments, when the % by weight of broad bean meal was below 5%, not only was the final protein content less satisfying, the linking function of the broad bean meal was less perceivable, the structure was subjectively perceived as less satisfying. In some embodiments, the range of between 3 and 15, between 5 and 10, or between 12% and 16% by weight of the broad bean meal was found suitable, and allowed to comply with the criteria of table 1. Other types of legumes or pulses than broad beans (Vicia faba, e.g., horse bean, fava bean or field bean), such as peas (e.g. garden peas or protein peas), dry beans (e.g., mung beans, white beans), chickpeas and lentils, may be used partially or entirely as alternatives to broad beans. Moreover, in embodiments where avoiding mandatory disclosure allergen ingredients is not a goal, soy beans may be used. Accordingly, in some embodiments, the food item has between 1 and 20%, between 3 and 15%, between 5 and 20% or between 5 and 10% by weight of legume meal.

In some embodiments, in addition to mashed dried fruit, seed meal, and legume meal as described above, the food item may have flavoring (e.g., one or more flavoring agent).

The flavoring can include one or more ingredients used mainly for the reason of giving an appreciable flavor to the food item. For instance, the food item can be provided in different flavors. A “brownies” flavor, for example, can include a chocolate aroma and cocoa powder as flavoring ingredients. A “berry” flavor, for example, can include a berry aroma and dried berries as flavoring ingredients. An “apple & cinnamon” flavor can include dried apples and cinnamon as flavoring ingredients as another example.

Categories of flavoring can include spices, fruits and aromas for instance. Flavoring can include carrot, cocoa powder, vanillin, dried apple cubes, dried berries, other dried fruit, and aromas, preferably natural aromas. Flavoring can be used in the range of 0 and 15%, or in the range of between 2 and 15% by weight of the final food item, for instance.

In some embodiments, in addition to mashed dried fruit, seed meal, and legume meal as described above, the food item may have one or more fibrous ingredients. The fibrous ingredient can be provided in a concentration of from 2 to 10 wt. % of the food item.

For example, insoluble fibers such as acacia, Jerusalem artichoke, apple and/or chicory root can be included to help reach a suitable structure of the food item. The one or more fibrous ingredients can absorb water. The one or more fibrous ingredients can be added to the structure to achieve a criteria of water activity below 0.69 while simultaneously and naturally providing nutritional fiber content. In some embodiments, acacia is chosen due to its prebiotic fiber feature. Acacia may be easier to digest than other alternatives such as chicory root which may cause bloating and gas in some embodiments. One or more fibrous ingredients may be added in a manner to reach a fibrous ingredient content at a range of 0%-10% by weight of the food item, such as 5% to 10% for instance.

In some embodiments, whole, minimally processed, plant-based materials can be selected for their synergistic ability to produce a nutritious food item that does not harden excessively with time, as would other snack bars made of ultra processed ingredients such as whey protein.

From a structural perspective, a technological challenge for food items such as shelf-stable snack bars include hardness and stickiness. During food processing, proteins may undergo cross-linking through Maillard reactions between reducing sugars and reactive lysine residues, which may have the effect of hardening. Maillard reaction-induced insoluble aggregates can be formed by peptide bond aggregation when water activity is in the range of 0.74-0.84, whereas nutrition food items such as bars typically have a water activity between 0.5 and 0.8. Maillard reactions may degrade the quality characteristics of the food item and lead to an undesirable flavor, undesirable color, and/or hardened texture.

The production of protein advanced glycosylation end products is directly related to the hardening of food items such as snack bars during storage. Polyphenols are known to significantly reduce the insolubility, aggregation, and sugar oxidation of food item snack bars during late-term storage. Naturally present polyphenols bind to the glycation sites of the proteins by reacting with active carbonyl groups, thereby blocking the sites available for glycation. This may impede or prevent Maillard reactions. Fruits and vegetables naturally contain polyphenols and thus can improve the storage and shelf life of the present food item. Berries, and apples are examples of polyphenol containing fruits. These could be added in the food item to provide dual action as flavoring and preservative.

In addition, dates, also contain significant amounts of polyphenols including phenolic acids (gallic, protocatechuic, hydroxybenzoic, vanillic, isovanillic, syringic, caffeic, ferulic, sinapic, p-coumaric, isoferulic), flavonoid glycosides (quercetin, luteolin, apigenin and kaempferol) and anthocyanidins. The dates can therefore be a preferred dried mashed fruit as they provide polyphenols in the composition which act as preservatives as explained above. The main phytochemicals in pumpkin seed are polyphenols, phytoestrogens, carotenoids, squalene and tocopherols. Furthermore, a total of 104 phenolics, mainly flavonoids, are present in broad beans. The main flavonoid compounds found in Broad beans, include flavanol monomers (such as gallocatechin, epipagallocatechin and catechin), proanthocyanidins (prodelphynidins and procyanidins), flavonols (glycosylated derivates of myricetin, quercetin and kaempferol), flavanonols, isoflavones (genistein and daidzein) and flavanones. Moreover, other phenolic compounds as also present in broad beans, including phenolic acids (caffeic acid, ferulic acid, p-coumaric acid and synaptic acid). For this reason, the combination of dates as the mashed dried fruit, pumpkin seeds as the seed meal and broad beans as the legume meal are desirable and advantageous not only with regards to the texture and taste achieved but also with regards to the shelf life of the food item. In some embodiments, the food item of the present disclosure achieves a water activity of 0.8 or below, 0.74 or below, or preferably 0.69 or below.

The polyphenols present in the raw materials may interact with the proteins, while the extent of Maillard reactions remains limited, promoting a hardness which can remain soft throughout shelf-life.

The food item structure may evolve during shelf-life, typically becoming harder, which makes it less desirable for consumers. In some embodiments, the texture profile of the food item was evaluated using a Stablemicrosystems TAXT2 texture analyzer. The sample snack bars were twice compressed by a 10 mm diameter probe. This method was used in order to determine hardness parameters such as rupture stress.

These evaluations show that hardness can be of at least 4 kPa, e.g., 5±1 kPa the day of production and can evolve to 8 kPa or more, e.g., 10±5 kPa, after 6 months shelf life which is an acceptable degree of hardening for consumers.

As can be understood, the examples described above and illustrated are intended to be exemplary only. The scope is indicated by the appended claims.

What is claimed is:

1. A food item comprising:
a solid structure occupying a volume and weighing at least 20 grams, the solid structure having a mix of:
from 30 to 50% by weight of at least one mashed dried fruit;
from 35 to 50% by weight of at least one seed meal; and
from 1 to 20% by weight of at least one legume meal.

2. The food item of claim 1 wherein the solid structure has a mix of between 40 and 50% by weight of the at least one mashed dried fruit, the at last one mashed dried fruit consisting of dates, between 40 and 50% by weight of the at least one seed meal, the at least one seed meal consisting of pumpkin seed, and between 5 and 15% by weight of the at least one legume meal, the at least one legume meal consisting of fava beans, and between 0 and 15% by weight of at least one other ingredient, wherein the total of the % by weight of the dates, pumpkin seed, fava beans and the at least one other natural ingredient is equal to 100%.

3. The food item of claim 1, wherein the mix is heterogeneous, at least 50% by weight of the at least one mashed dried fruit consist of mashed dates, at least 50% by weight of the at least one seed meal consists of crushed squash seed, and the mix has from 3 to 20% by weight of the at least one legume meal, and from 0.5 to 15% by weight of one or more other ingredient and wherein the solid structure occupies a rectangular parallelepiped volume and weighs between 20 and 70 grams.

4. The food item of claim 1 wherein the mix further includes from 0 to 34% by weight of at least one other ingredient; wherein the total of the % by weight of the at least one dried fruit, the at least one seed meal, the at least one legume, and the at least one other ingredient being equal to 100%.

5. The food item of claim 1, wherein the solid structure weighs between 20 and 55 grams, contains more than 4 grams of protein, more than 2 grams of fiber, has less than 250 calories, has a caloric density index between 4 and 10 calories per gram, has a glycemic index below 55, preferably between 35 and 45.

6. The food item of claim 1, wherein the solid structure has from 35 to 45% by weight of the at least one seed meal.

7. The food item of claim 1, wherein the solid structure has from 5 to 20% by weight of the at least one legume meal.

8. The food item of claim 1, wherein the at least one mashed dried fruit has from 90 to 100% by weight of mashed dates.

9. The food item of claim 1, wherein the solid structure has from 35 to 45% by weight of the at least one mashed dried fruit.

10. The food item of claim 1, wherein at least 80% by weight of the at least one mashed dried fruit has a granulometry below 2000 μm.

11. The food item of claim 1, wherein the at least one seed meal has from 50 to 100% by weight of squash seeds.

12. The food item of claim 1, wherein at least 80% of the at least one seed meal has a granulometry below than 2000 μm.

13. The food item of claim 1, wherein the at least one legume meal has from 50 to 100% by weight of broad beans.

14. The food item of claim 1, wherein the at least one legume meal has 90% of particles at 150 μm or less, at a moisture of 10% of less.

15. The food item of claim 1, wherein the solid structure exhibits a water activity of below 0.80.

16. The food item of claim 2, wherein the at least one other ingredient consists of at least one natural ingredient.

17. The food item of claim 2, wherein the at least one other ingredient has at least one flavoring agent at a concentration of from 2 to 15% by weight of the solid structure.

18. The food item of claim 17 wherein the at least one natural ingredient has at least one fibrous ingredient at a concentration of from 0 to 10% by weight of the solid structure, wherein the total % by weight of the at least one mashed dried fruit, at least one seed meal, at least one legume meal, at least one flavoring agent, and at least one fibrous ingredient is equal to 100%.

19. The food item of claim 18 wherein the fibrous ingredient is at a concentration of from 2 to 10% by weight of the solid structure.

20. A process of making food items, the process comprising: blending between 30 and 50% by weight of one or more dried fruits with between 35 and 50% by weight of one or more seeds, between 1 and 20% by weight of one or more legume meal, and between 0 and 34% by weight of one or more natural ingredient to form a food item mix;
compacting the food item mix into a slab having a density between 1.25 and 1.65 g/cm³; and
cutting the slab into a plurality of food items each having between 20 and 70 grams.

21. The process of claim 20 wherein said blending includes crushing the seeds and mixing the dried fruit into the crushed seeds.

22. The process of claim 21 wherein said blending includes mixing the legume meal into the mixed dried fruit and crushed seeds.
